(19) United States
(12) Patent Application Publication
(10) Pub. No.: US 2018/0130129 A1
(43) Pub. Date: May 10, 2018

(54) SYSTEM FOR DETERMINING REAL-TIME PRICE RELATIVE STRENGTH VALUE OF INVESTMENT PRODUCT

(71) Applicant: ISTERA COMPANY LIMITED, Keelung City (TW)

(72) Inventor: Tseng-Sheng CHO, Keelung City (TW)

(21) Appl. No.: 15/345,963

(22) Filed: Nov. 8, 2016

(51) Int. Cl. G06Q 40/04; G06Q 40/06

(52) U.S. Cl. CPC G06Q 40/04; G06Q 40/06

(57) ABSTRACT

A system for determining a relative strength trend of investment products analyzes and determines a relative strength trend of an investment product directly and quickly and computes a real-time price relative strength value index (RPRSVI) of the investment product in trading or after-hour trading, The system determines a relative safe sell signal or a relative safe buy signal according to a change of RPRSVI that reaches a predetermined value of the system, so that investors can know about the relative strength trend and buy and sell signals of the investment product according to the RPRSVI and the signals determined by the system and distinguish the sell and buy the trading time point and the price strength index, so as to increase the opportunity for profit.

### FIELD OF THE INVENTION

The present invention relates to a system for determining relative strength trend of investment products, and more particularly to a system capable of providing a relative safe sell signal or a relative safe buy signal to investors as a reference to decide the buying and selling points.

### BACKGROUND OF THE INVENTION

### 1. Description of the Related Art

The investment of stocks and their derivative financial products has always been the most favorable financial management to the general public. It is definitely what investors want most to obtain price information of a certain stock among a variety of stocks in advance, understand the relative strength of the stock through a relative strength index of the stock, and a correct buying and selling strategy.

To cope with the aforementioned requirements, indexes including KD, RSI, etc are developed by the related industry to provide reference and determination value to a specific level. However, statistical probability indicates that a particular stock has a much smaller chance of going up after it has gone up to a certain level. Now, investors may choose a wrong up or down direction, a wrong selling or buying price, and a wrong time point easily, and thus causing a lower investment performance.

Therefore, it is a main subject of the related industry to develop a system for analyzing and determining the relative strength and trend of investment products quickly, while showing the relative strength and trend in a simple display manner, so that the investors can use the relative strength and trend as a reference for determining the buying and selling points and making a quick and definite decision for their investment.

### 2. Summary of the Invention

Therefore, it is a primary objective of the present invention to provide a system for determining a relative strength trend of investment products, wherein the system perform computations according to a plurality of trading data in a stock market database, and the trading data include stock name, stock code, date, and price data.

The system comprises a data capture device, and a data computing device, and the data capture device is coupled to the external stock market database, and the data computing device is coupled to the data capture device. The data computing device comprises a trading data set, a control instruction, an input device, a computing device, and a RPRSVI.

The trading data set of the data computing device is coupled to the data capture device, and the data capture device captures a plurality of trading data from the stock market database and stores the plurality of trading data into the trading data set.

The control instruction is coupled to the trading data set, the input device, and the computing device.

Wherein, the computing device generates a RPRSVI through the index formula, and the RPRSVI is represented by R in the index formula, and the index formula is given below:

R=W₁((Pₜ−P_{5T})÷P_{5T})+W₂((Pₜ−P_{10T})÷P_{10T})+W₃((Pₜ−P_{20T})+W₄((Pₜ−P_{60T})÷P_{60T})+W₅((Pₜ−P_{180T})÷P_{180T})+W₆((Pₜ−P_{360T})÷P_{360T})

Where, W₁, W₂, W₃, W₄, W₅, and W₆ are optimal weight values determined by the index formula, Pₜ is the real-time price of an investment product, P_{5T} is an average price of 5 days, P_{10T} is an average price of 10 days, P_{20T} is an average price of 20 days, P_{60T} is an average price of 60 days, P_{180T} is an average price of 180 days, and P_{360T} is an average price of 360 days.

A relative safe buy and sell interval (a₂,a₁) set by an investor or provided by the control instruction, and when R≥a₁, a relative safe sell signal is determined; and when R≤a₂, a relative safe buy signal is determined, so that a relative strength trend and appropriate bull and bear trading points of the investment product can be determined according to the RPRSVI and the relative safe buy and sell interval (a₂,a₁).

Wherein, the R value falls within an interval [−10,10].

Wherein, when the RPRSVI rises to a₁ for the first time within a trading day, the price of the investment product is the relative safe selling price provided and determined by the system, and when the RPRSVI drops to a₂ for the first time within a trading day, the price of the investment product is the relative safe buying price provided and determined by the system.

Wherein, the relative safe buy and sell interval (a2,a1) provided by the control instruction means that and the control instruction compares and performs the statistics of a strength sequence list of past data in the trading data set of according to the stock of a company corresponsive to the stock code within a transaction time period to obtain the value of a1 set at the relative safe selling price of the stock, and a1 is a trigger point of a sell signal, and the control instruction compares and performs the statistics of a strength sequence list of past data in the trading data set to obtain the value of a2 set at the relative safe buying price of the stock, and a2 is a trigger point of a buy signal.

The strength sequence list of the past data refers to the RPRSVI obtained according to the index formula of the present invention within a transaction time period, and the range of such transaction time period is selected by investors, and the sequence list formed by the RPRSVI (represented by R in the index formula) according to the index formula; wherein the real-time price Pₜ of the investment product of the index formula includes the real-time prices of the following time points within the transaction time periods such as opening, closing, stock price highest point, stock price lowest point, buy trigger point, and sell trigger point. The sequence list formed by the R values completely shows all R values within the price up-and-down fluctuation range in every trading day. The R value obtained by comparing and performing the statistics in order to find the relative safe selling price of the stock by the present invention according to the distribution of the strength sequence list within the transaction time period is a₁, wherein a₁ is a trigger point of a sell signal; and the R value obtained by comparing and performing the statistics in order to find the relative safe buying price of the stock is a₂, wherein a₂ is a trigger point of a buy signal.

Wherein, the relative safe buy and sell interval (a2,a1) set by an investor means that the investor inputs the set relative safe buy and sell interval (a2,a1) through the input device, and the broader the relative safe buy and sell interval (a2,a1), the higher the opportunity of maintaining the original shareholding situation, wherein a1 is a trigger point of a sell signal, and a2 is a trigger point of a buy signal.

Wherein, this system further comprising a display device coupled to the computing device, and the display device being provided for displaying the RPRSVI, the relative safe buy and sell interval (a₂,a₁) provided by the control instruction, the relative safe buy and sell interval (a₂,a₁) provided by the investor setting, the relative safe selling price provided by the system and the relative safe buying price provided by the system.

Wherein, the display device further displays the plurality of trading data.

Wherein, the display device further displays a plurality of sequential data of past high points and low points of the set stock and provides the sequential data for the investor's reference, when the investor sets the relative safe buy and sell interval (a₂,a₁).

Wherein, this system further comprises a strong buy and sell interval (d₂,d₁), wherein d₁>a₁, and d₂<a₂, and when R≥d₁, a strong sell signal is determined, or when R≤d₂, a strong buy signal is determined, wherein the price corresponding to the RPRSVI rising to d₁ for the first time within a trading day is the strong selling price determined and provided by the system, and the price corresponding to the RPRSVI dropping to d₂ for the first time within a trading day is a strong buying price determined and provided by the system.

Wherein, this system further provides an absolute buy and sell interval (e₂,e₁), wherein e₁>d₁ and e₂<d₂, and when R≥e₁, an absolute sell signal is determined, or when R≤e₂, an absolute buy signal is determined, and a price corresponding to the RPRSVI rising to e₁ for the first time within a trading day is an absolute selling price determined and provided by the system, and a price corresponding to the RPRSVI dropping to e₂ for the first time within a trading day is an absolute buying price determined and provided by the system.

Wherein, this system further providing a bull and bear portion reverse interval (f₂,f₁), and f₁>e₁ and f₂<e₂, and when R≥f₁, a bull portion liquidated and turned over to a bear portion indicating a sell signal is determined, or when R≤f₂, a bear portion liquidated and turned over to a bull portion indicating a buy signal is determined, and the price corresponding to the RPRSVI rising to f₁ for the first time within a trading day is a bull portion liquidated and turned over to a bear portion selling price and determined by the system, and the price corresponding to the RPRSVI dropping to f₂ for the first time within a trading day is a bear portion liquidated and turned over to a bull portion buying price and determined by the system.

Wherein, the relative safe selling price, the relative safe buying price, the strong selling price, the strong buying price, the absolute selling price, the absolute buying price, the bull portion liquidated and turned over to a bear portion selling price, and the bear portion liquidated and turned over to a bull portion buying price are displayed with different fonts, text colors, text sizes, text thickness, or background color blocks on the display device, so that the investor can distinguish the sell and buy opportunities quickly and intuitively.

Wherein, this system is installed to a mobile phone, a stock machine, a tablet PC, a notebook computer, a desktop computer, an internet television or an internet of things device.

In summation, the present invention provides a number (Real-time Price Relative Strength Value of Investment (RPRSVI), so that investors can know about the rising or declining trends of a particular stock and use these trends for making the decision on the buying and selling points, and the system determines a relative safe sell signal or a relative safe buy signal according to the change of real-time price relative strength value to a predetermined value. Therefore, the investors can understand the relative strength trend of an investment product based on the real-time price relative strength value and the signals determined by the system and distinguish a trading time point and a price strength index to increase the opportunity for profit.

### BRIEF DESCRIPTION OF THE DRAWINGS

FIG. 1 is a functional block diagram of a system for determining relative strength trend of investment products of the present invention;

FIG. 2 is a table listing a RPRSVI (R value) and a determination result computed by using the index formula of the present invention; and

FIG. 3 is a schematic view of a system for determining relative strength trend of investment products of the present invention and capable of providing more determination signals.

### DESCRIPTION OF THE PREFERRED EMBODIMENTS

The above and other objects, features and advantages of this disclosure will become apparent from the following detailed description taken with the accompanying drawings.

The present invention discloses a system for determining a relative strength trend of investment products, and the primary objective of the present invention is to provide a number RPRSVI (which is called Real-time Price Relative Strength Value of Investment products) for investors to know about the price rise or drop of a particular stock and use the number as a reference to make decisions on buying and selling points.

Specifically, the system for determining relative strength trend of investment products of the present invention is based on the principle of statistical probability. If the price of a stock rises up to a certain level, the probability for such stock to rise further will be smaller, so that investors may determine the strength of selling according to the rising strength of the stock (which is the RPRSVI of the present invention). Similarly, if the price of a stock drops to a certain level, the probability for such stock to drop further will be smaller, so that the investors may determine the strength of buying according to the dropping strength of such stock (which is the RPRSVI of the present invention). The system for determining relative strength trend of investment products in accordance with the present invention provides a relative safe buy and sell interval (a₂,a₁) according to historical data and lets investors determine the real-time relative strength trend of the investment product according to the RPRSVI and the relative safe buy and sell interval (a₂,a₁).

The basic structure of the system for determining relative strength trend of investment products in accordance with the present invention will be described as follows. The present invention discloses a determination system used for computing a plurality of trading data stored in a stock market database. The aforementioned trading data include corresponsive time data.

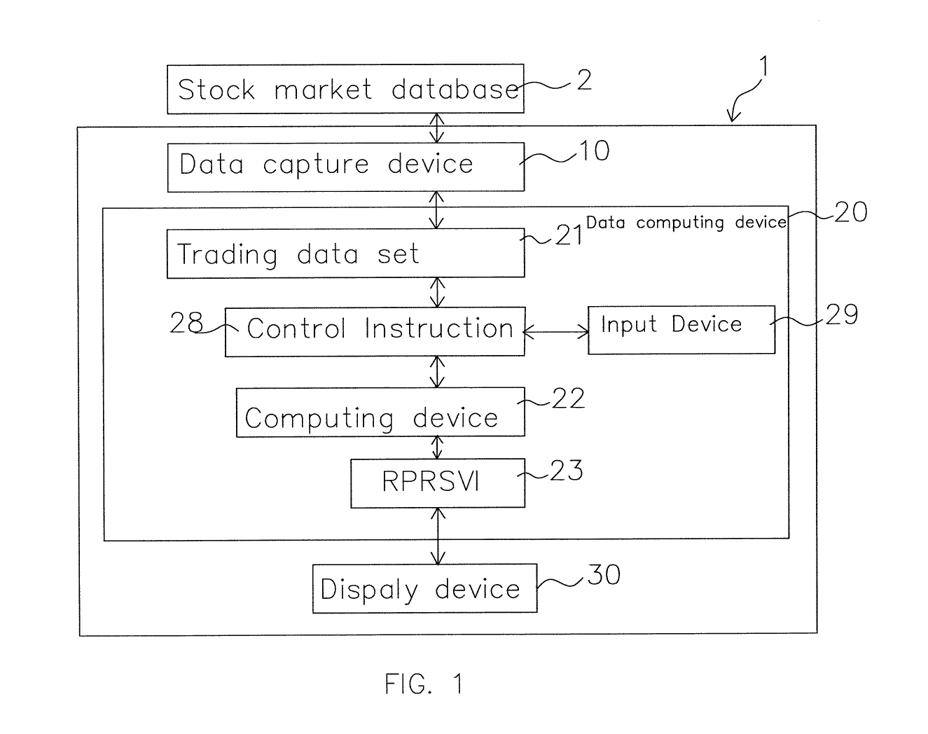

With reference to FIG. 1 for a functional block diagram of a system for determining a relative strength trend of investment products in accordance with the present invention, the present invention provides a system for determining a relative strength trend of investment products, and the system computes a plurality of trading data in a stock market database 2, wherein the trading data include a corresponsive stock name, stock code, date and price data.

In FIG. 1, the system for determining a relative strength trend of investment products 1 of the present invention comprises a data capture device 10, and a data computing device 20, and the system for determining relative strength trend of investment products 1 may be installed to any electronic device such as a mobile phone, a stock machine, a tablet PC, a notebook computer, a desktop computer, a network television, internet of things device, etc, but the invention is not limited to these devices only.

The data capture device 10 is coupled to the external stock market database 2, and the data computing device 20 is coupled to the data capture device 10. The data computing device 20 includes a trading data set 21, a control instruction 28, an input device 29, a computing device 22, and a RPRSVI 23.

The trading data set 21 of the data computing device 20 is coupled to the data capture device 10, and the data capture device 10 captures a plurality of trading data automatically from the stock market database 2 by using a frequency or a cycle or an investor's input condition and stores the plurality of trading data into the trading data set 21. Specifically, the data capture device 10 captures a plurality of corresponding trading data from an online or offline database stored with related stock data according to a system default condition or an investor's input condition. The trading data include code, name, selling/buying price, trading time, trading quantity of a stock, and other data such as settlement time or stock type, etc.

After the data capture device 10 obtains the trading data, the trading data are stored and recorded into the trading data set 21 of the data computing device 20 and used for future analysis and processing.

The control instruction 28, the trading data set 21, the input device 29, and the computing device 22 are coupled to one another.

Wherein, the computing device 22 generates a RPRSVI 23 through the index formula, and the RPRSVI 23 in the index formula is represented by R, and the index formula is given below:

R=W₁((Pₜ−P_{5T})÷P_{5T})+W₂((Pₜ−P_{10T})÷P_{10T})+W₃((Pₜ−P_{20T})+W₄((Pₜ−P_{60T})÷P_{60T})+W₅((Pₜ−P_{180T})÷P_{180T})+W₆((Pₜ−P_{360T})÷P_{360T})

Wherein, W₁, W₂, W₃, W₄, W₅, and W₆ are optimal weight values determined by the index formula; Pₜ is a real-time price of an investment product; P_{5T} is an average price of 5 days, P_{10T} is an average price of 10 days, P_{20T} is an average price of 20 days, P_{60T} is an average price of 60 days, P_{180T} is average price of 180 days, and P_{360T} is an average price of 360 days.

The investors may set or use a relative safe buy and sell interval (a₂,a₁) provided by the control instruction 28. When R≥a₁, a relative safe sell signal is determined; when R≤a₂, a relative safe buy signal is determined. Therefore, a relative strength trend of an investment product can be determined according to the RPRSVI 23 and the relative safe buy and sell interval (a₂,a₁).

The larger the absolute value □R□, the larger the opportunity of triggering the buying and selling points, and the more significant the deviation of bull and bear situations of the investment product, and thus the larger the opportunity of having the buying and selling points shown up. On the other hand, the smaller the absolute value □R□, the smaller the opportunity of triggering the buying and selling points, and thus the larger opportunity of the investment product falling in a consolidation stage.

To let the investors distinguish the sell and buy opportunities according to the RPRSVI 23 quickly and intuitively, the present invention limits the RPRSVI 23 (which is the R value) within an interval [−10,10].

Wherein, the price corresponding to the RPRSVI 23 rising to a₁ for the first time within a trading day is the relative safe selling price determined by the system, and the price corresponding to the RPRSVI 23 dropping to a₂ for the first time within a trading day is the relative safe buying price determined by the system.

Wherein, if the investor uses the relative safe buy and sell interval (a₂,a₁) provided by the control instruction, then the control instruction 28 will compare and perform the statistics of a strength sequence list of past data in the trading data set of according to the stock of a company corresponsive to the stock code within a transaction time period to obtain the value of a₁ set at the relative safe selling price of the stock, and a₁ is a trigger point of a sell signal, and the control instruction compares and performs the statistics of a strength sequence list of past data in the trading data set 21 to obtain the value of a₁ set at the relative safe buying price of the stock, and a₁ is a trigger point of a sell signal, or the control instruction will compare and perform the statistics of the statistics of a strength sequence list of past data in the trading data set 21 to obtain the value of a₂ set at the relative safe buying price of the stock, and a₂ is a trigger point of a buy signal.

The strength sequence list of the past data refers to the RPRSVI obtained according to the index formula of the present invention within a transaction time period, and the range of such transaction time period is selected by the investor, and the sequence list formed by the RPRSVI (represented by R in the index formula) according to the index formula of the present invention; wherein the real-time price of the investment product in the index formula includes the real-time prices of the following time points within the transaction time periods such as opening, closing, stock price highest point, stock price lowest point, buy trigger point, and sell trigger point, and the sequence list formed by the R values completely shows all R values within the price up-and-down fluctuation range in every trading day; and R value obtained by comparing and performing the statistics to obtain the relative safe selling price of the stock by the present invention according to the distribution of the strength sequence list within the transaction time period is a₁, wherein a₁ is a trigger point of a sell signal; and the R value obtained by comparing and performing the statistics to obtain the relative safe buying price of the stock is a₂, wherein a₂ is a trigger point of a buy signal.

Wherein, the investor may set the relative safe buy and sell interval (a₂,a₁) according to personal risk tolerance. In other words, the relative safe buy and sell interval (a₂,a₁) set by the investor is inputted through the input device 29 by the investor. The broader the relative safe buy and sell interval (a₂,a₁), the larger opportunity of maintaining the original shareholding situation, wherein a₁ is a trigger point of a sell signal, and a₂ is a trigger point of a buy signal.

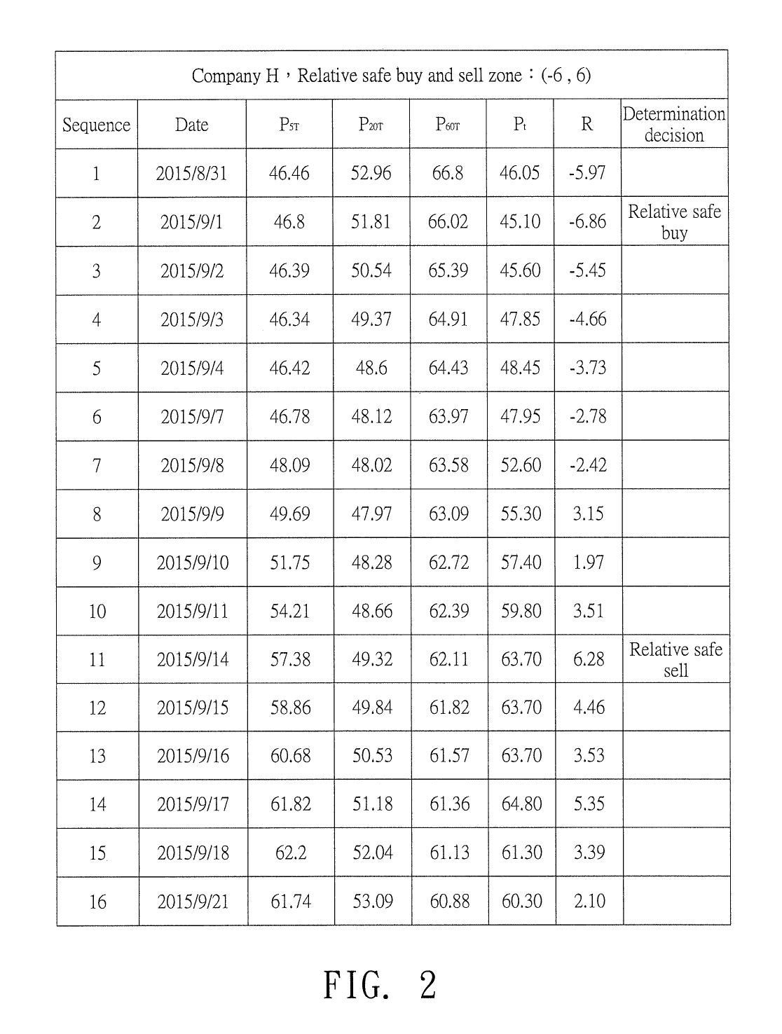

With reference to FIG. 2 for a real-time price relative strength value (which is the R value) of an investment product of Company H computed by the index formula of the present invention, Company H is used as an example, and its relative safe buy and sell interval (a₂,a₁) is (−6, 6), and the data P_{10T}, P_{180T}, and P_{360T} are omitted, and the optimal weight values W₂, W₅, and W₆ are set to 0. The R value of each of 16 trading days listed in FIG. 2, and the R values of these trading days are compared with the relative safe buy and sell interval (−6, 6). We can observe that the R value of the 2^{nd} trading day ≤−6, so that a relative safe buy signal is determined. If the R value ≤−6, a trigger point of a buy signal has been reached, and the investor may buy the investment product in a relatively safer manner. In other words, the investment product has been dropping substantially in the 2^{nd} trading day, and the drop has exceeded the relative safe buy and sell interval (a₂,a₁), and the chance for further drop is small, so that the system determines it as a relative safe buy signal and suggest the investor to buy in. In FIG. 2, we can observe that the price has gone up in the 3^{rd}˜10^{th} trading days, so that it will be profitable to buy in on the 2^{nd} trading day.

On the other hand, we can see that the R value ≥6 on the 11^{th} trading day, so that the system determines it as a relative safe sell signal. When the R value ≥6, a trigger point of a sell signal has reached, and the investor may sell the investment product in a relatively safe manner. In other words, the investment product has risen substantially on the 11^{th} trading day, and the rise has exceeded the relative safe buy and sell interval (a₂,a₁), and the chance for a further rise is small, so that the system determines it as a relative safe sell signal and suggests the investor to sell out. In FIG. 2, we can see that the price drops mostly in the 12^{th}˜16^{th} trading days, so that it will be profitable if the investor sells out on the 11^{th} trading day. It is noteworthy that the R values of the 1^{st}, 3^{rd}˜10^{th}, and 12˜16^{th} trading days fall within the relative safe buy and sell interval (−6, 6), and no trigger point of a buy signal or a sell signal appears, and it means that the investment product is situated at a consolidation stage. In this example, we can see that the investor can quickly and intuitively distinguish the selling and buying opportunities according to the RPRSVI 23 by using the index formula of the present invention.

In addition, the system for determining relative strength trend of investment products in accordance with the present invention further comprises a display device 30 coupled to the computing device 22, and the display device 30 is provided for displaying the RPRSVI 23, and the investor may set the relative safe buy and sell interval (a₂,a₁) provided by the control instruction, and the relative safe selling price and the relative safe buying price provided by the system.

Wherein, the display device 30 further displays the plurality of trading data.

Wherein, the display device 30 further displays a plurality of sequential data of past high points and low points of the set stock and provides the sequential data for the investor's reference, when the investor sets the relative safe buy and sell interval (a₂,a₁).

Wherein, the display device 30 may be a touch display device, and if the display device 30 is a touch display device, the display device 30 will serves as the input device 29 as well.

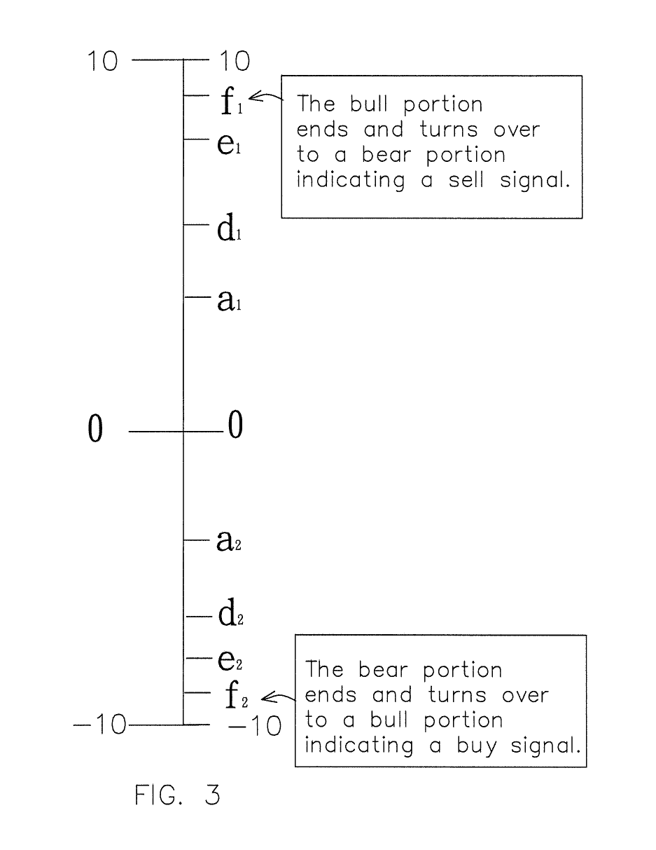

With reference to FIG. 3 for the schematic view of a system for determining relative strength trend of investment products in accordance with the present invention and capable of providing more determination signals, the system further provides a strong buy and sell interval (d₂,d₁), wherein a strong buy and sell interval (d₂,d₁), wherein d₁>a₁, and d₂<a₂, and when R≥d₁, a strong sell signal is determined, or when R≤d₂, a strong buy signal is determined, and the price corresponding to the RPRSVI rising to d₁ for the first time within a trading day is the strong selling price determined and provided by the system, and the price corresponding to the RPRSVI dropping to d₂ for the first time within a trading day is a strong buying price determined and provided by the system.

This system further provides an absolute buy and sell interval (e₂,e₁), wherein e₁>d₁ and e₂<d₂, and when R≥e₁, an absolute sell signal is determined, or when R≤e₂, an absolute buy signal is determined, and a price corresponding to the RPRSVI rising to e₁ for the first time within a trading day is an absolute selling price determined and provided by the system, and a price corresponding to the RPRSVI dropping to e₂ for the first time within a trading day is an absolute buying price determined and provided by the system.

This system further provides a bull and bear portion reverse interval (f₂,f₁), and f₁>e₁ and f₂<e₂, and when R≥f₁, a bull portion liquidated and turned over to a bear portion indicating a sell signal is determined, or when R≤f₂, a bear portion liquidated and turned over to a bull portion indicating a buy signal is determined, and the price corresponding to the RPRSVI rising to f₁ for the first time within a trading day is a selling price occurred when a bull portion liquidated and turns over to a bear portion provided and determined by the system is determined, and the price corresponding to the RPRSVI dropping to f₂ for the first time within a trading day is a buying price occurred when a bear portion liquidated and turns over to a bull portion provided and determined by the system.

In addition, this system also provides a thoughtful design to investors, wherein the relative safe selling price, the relative safe buying price, the strong selling price, the strong buying price, the absolute selling price, the absolute buying price, the selling price occurred when a bull portion liquidated and turns over to a bear portion, and the buying price occurred when a bear portion liquidated and turns over to a bull portion are displayed with different fonts, text colors, text sizes, text thickness, or background color blocks on the display device, so that the investor can distinguish the sell and buy opportunities quickly and intuitively.

In summation of the description above, the present invention has the advantage of providing a number: Real-time Price Relative Strength Value of Investment products (RPRSVI), so that investors can know about the rising or declining trends of a particular stock and use these trends for making the decision on the buying and selling points, and the system determines a relative safe sell signal or a relative safe buy signal according to the change of real-time price relative strength value to a predetermined value. Therefore, the investors can understand the relative strength trend of an investment product based on the real-time price relative strength value and the signals determined by the system and distinguish a trading time point and a price strength index to increase the opportunity for profit.

What is claimed is:

1. A system for determining a relative strength trend of investment products by computing a plurality of trading data of a stock market database, and the plurality of trading data including a stock name, a stock code, a date and price data;
the system comprising a data capture device and a data computing device, and the data capture device being coupled to the external stock market database, and the data computing device being coupled to the data capture device;
the data computing device comprising a trading data set, a control instruction, an input device, a computing device, and a real-time price relative strength value of investment products (RPRSVI);
the trading data set of the data computing device being coupled to the data capture device, and the data capture device capturing a plurality of trading data from the stock market database, and storing the plurality of trading data into the trading data set;
the control instruction being coupled to the trading data set, the input device, and the computing device;
wherein, the computing device generates a RPRSVI by the index formula given below (and RPRSVI represented by R in the index formula):
R=W₁((Pₜ−P_{5T})÷P_{5T})+W₂((Pₜ−P_{10T})÷P_{10T})+W₃((Pₜ−P_{20T})+W₄((Pₜ−P_{60T})÷P_{60T})+W₅((Pₜ−P_{180T})÷P_{180T})+W₆((Pₜ−P_{360T})÷P_{360T})
wherein W₁, W₂, W₃, W₄, W₅, W₆ are optimal weight values determined by the index formula; Pₜ is a real-time price of an investment product; P_{5T} is an average price of 5 days, P_{10T} is an average price of 10 days, P_{20T} is an average price of 20 days, P_{60T} is an average price of 60 days, P_{180T} is an average price of 180 days, and P_{360T} is an average price of 360 days; a relative safe buy and sell interval (a₂,a₁) set by an investor or provided by the control instruction, and when R≥a₁, a relative safe sell signal is determined; and when R≤a₂, a relative safe buy signal is determined, so that a relative strength trend and appropriate bull and bear trading points of the investment product can be determined according to the RPRSVI and the relative safe buy and sell interval (a₂,a₁).

2. The system for determining a relative strength trend of investment products according to claim 1, wherein the value of R falls within an interval [−10,10].

3. The system for determining a relative strength trend of investment products according to claim 2, wherein when the RPRSVI rises to a₁ for the first time within a trading day, the price of the investment product is the relative safe selling price provided and determined by the system, and when the RPRSVI drops to a₂ for the first time within a trading day, the price of the investment product is the relative safe buying price provided and determined by the system.

4. The system for determining a relative strength trend of investment products according to claim 3, wherein the relative safe buy and sell interval (a₂,a₁) provided by the control instruction means that and the control instruction compares and performs the statistics of a strength sequence list of past data in the trading data set of according to the stock of a company corresponsive to the stock code within a transaction time period to obtain the value of a₁ set at the relative safe selling price of the stock, and a₁ is a trigger point of a sell signal, and the control instruction compares and performs the statistics of a strength sequence list of past data in the trading data set to obtain the value of a₂ set at the relative safe buying price of the stock, and a₂ is a trigger point of a buy signal.

5. The system for determining a relative strength trend of investment products according to claim 4, wherein the strength sequence list of the past data refers to the RPRSVI obtained according to the index formula within a transaction time period, and the range of such transaction time period is selected by the investor, and the sequence list formed by the RPRSVI (represented by R in the index formula) according to the index formula; wherein the real-time price of the investment product in the index formula includes the real-time prices of the following time points within the transaction time periods such as opening, closing, stock price highest point, stock price lowest point, buy trigger point, and sell trigger point, and the sequence list formed by the R values completely shows all R values within the price up-and-down fluctuation range in every trading day; and R value obtained by comparing and performing the statistics to obtain the relative safe selling price of the stock according to a distribution of the strength sequence list within the transaction time period is a₁, wherein a₁ is a trigger point of a sell signal; and the R value obtained by comparing and performing the statistics to obtain the relative safe buying price of the stock is a₂, wherein a₂ is a trigger point of a buy signal.

6. The system for determining a relative strength trend of investment products according to claim 4, wherein the relative safe buy and sell interval (a₂,a₁) set by an investor means that the investor inputs the set relative safe buy and sell interval (a₂,a₁) through the input device, and the broader the relative safe buy and sell interval (a₂,a₁), the higher the opportunity of maintaining the original shareholding situation, wherein a₁ is a trigger point of a sell signal, and a₂ is a trigger point of a buy signal.

7. The system for determining a relative strength trend of investment products according to claim 4, further comprising a display device coupled to the computing device, and the display device being provided for displaying the RPRSVI, the relative safe buy and sell interval (a₂,a₁) provided by the control instruction, the relative safe buy and sell interval (a₂,a₁) provided by the investor setting, the relative safe selling price provided by the system and the relative safe buying price provided by the system.

8. The system for determining a relative strength trend of investment products according to claim 7, wherein the display device further displays the plurality of trading data.

9. The system for determining a relative strength trend of investment products according to claim 8, wherein the display device further displays a plurality of sequential data of past high points and low points of the set stock and provides the sequential data for the investor's reference, when the investor sets the relative safe buy and sell interval (a₂,a₁).

10. The system for determining a relative strength trend of investment products according to claim 9, further providing a strong buy and sell interval (d₂,d₁), wherein d₁>a₁, and d₂<a₂, and when R≥d₁, a strong sell signal is determined, or when R≤d₂, a strong buy signal is determined, and the price corresponding to the RPRSVI rising to d₁ for the first time within a trading day is the strong selling price determined and provided by the system, and the price corresponding to the RPRSVI dropping to d₂ for the first time within a trading day is a strong buying price determined and provided by the system.

11. The system for determining a relative strength trend of investment products according to claim 10, further providing an absolute buy and sell interval (e₂,e₁), wherein e₁>d₁ and e₂<d₂, and when R≥e₁, an absolute sell signal is determined, or when R≤e₂, an absolute buy signal is determined, and a price corresponding to the RPRSVI rising to e₁ for the first time within a trading day is an absolute selling price determined and provided by the system, and a price corresponding to the RPRSVI dropping to e₂ for the first time within a trading day is an absolute buying price determined and provided by the system.

12. The system for determining a relative strength trend of investment products according to claim 11, further providing a bull and bear portion reverse interval (f₂,f₁), and f₁>e₁ and f₂<e₂, and when R≥f₁, a bull portion liquidated and turned over to a bear portion indicating a sell signal is determined, or when R≤f₂, a bear portion liquidated and turned over to a bull portion indicating a buy signal is determined, and the price corresponding to the RPRSVI rising to f₁ for the first time within a trading day is a bull portion liquidated and turned over to a bear portion selling price and determined by the system, and the price corresponding to the RPRSVI dropping to f₂ for the first time within a trading day is a bear portion liquidated and turned over to a bull portion buying price and determined by the system.

13. The system for determining a relative strength trend of investment products according to claim 12, wherein the relative safe selling price, the relative safe buying price, the strong selling price, the strong buying price, the absolute selling price, the absolute buying price, the bull portion liquidated and turned over to a bear portion selling price, and the bear portion liquidated and turned over to a bull portion buying price are displayed with different fonts, text colors, text sizes, text thickness, or background color blocks on the display device, so that the investor can distinguish the sell and buy opportunities quickly and intuitively.

14. The system for determining relative strength trend of investment products according to claim 1, being installed to a mobile phone, a stock machine, a tablet PC, a notebook computer, a desktop computer, an internet television or an internet of things device.
